(19) United States
(12) Patent Application Publication
(10) Pub. No.: US 2012/0111253 A1
(43) Pub. Date: May 10, 2012

(54) INTEGRATED HULL AND SUPPORT STRUCTURE FOR WATERCRAFT

(76) Inventors: Terry George Aff, Monticello, KY (US); Bruce Jones Chesnut, Monticello, KY (US); William Ernest Jasper, Monticello, KY (US)

(21) Appl. No.: 13/293,682

(22) Filed: Nov. 10, 2011

Related U.S. Application Data
(60) Provisional application No. 61/412,090, filed on Nov. 10, 2010.

(51) Int. Cl. B63B 3/00; B23P 11/00; B63B 3/48; B63B 19/26; B63B 3/26; B63B 3/16

(52) U.S. Cl. 114/84; 114/65 R; 29/428

(57) ABSTRACT

A watercraft includes a hull defined by hull frame members. One or more supports extend vertically from at least one hull frame member and above a topline of the hull to define a portion of a compartment of the watercraft, providing structural support for both the hull and the compartment. Other features include an upper deck cover including an integrated drainage system, and a composite hull design improving insulation, buoyancy, water-tightness, and rigidity of the watercraft hull. A method of making a watercraft providing the above features is disclosed.

This application claims the benefit of priority in U.S. Provisional Patent Application Ser. No. 61/412,090 filed on Nov. 10, 2010, the entirety of which is incorporated herein by reference.

### TECHNICAL FIELD OF THE INVENTION

The present disclosure relates to watercraft, especially watercraft such as houseboats including extensive living and/or recreational facilities. In particular, the disclosure relates to an integrated hull support structure for a watercraft, wherein the support structure supports an upper element of the watercraft and also provides structural support for the watercraft hull. The hull structure includes a composite design providing superior buoyancy, rigidity, and insulative value.

### BACKGROUND OF THE INVENTION

Watercraft such as houseboats are typically provided with a hull adapted to float on and move across the surface of a body of water, as well as propulsion and steering means allowing the user to travel as desired. Exemplary hull designs include a flat-bottom hull, a V-bottom hull, a pontoon-type hull, and others. Houseboats are also typically provided with living and/or recreational facilities of a variety of configurations supported on the hull. Such facilities may range from simple sleeping quarters, on the one hand, to more luxurious accommodations including bedrooms, bathrooms, living rooms or interior sitting areas, kitchens, dining rooms, and a variety of recreational areas, on the other hand. Still more elements may be included, such as interior climate control means, on-board potable water sources, laundry facilities, entertainment centers, and the like. Such vessels are, indeed, waterborne homes providing any conceivable comfort available in a terrestrial home.

Representatively, watercraft include a hull, at least one compartment disposed at least partially above the hull wherein are located the living quarters and optionally other elements summarized above, and at least one upper deck which is often also utilized for an entertainment or recreational area. Depending on the construction of the watercraft, at least a portion of the hull may also define at least a portion of one or more sidewalls of the living quarters, etc. For this reason, the floor of the upper deck is often supported by and coplanar with a roof or ceiling element of the at least one compartment. The upper deck may simply consist of an open usable space, or may be modified to provide a more elaborate facility including sidewalls or railings, flooring, furniture, recreational facilities such as hot tubs/spas, and the like.

The upper deck, by reason of its position, is highly exposed to the elements, i.e., sun, wind, rain, etc. For that reason, it is known in this art to provide the upper deck with a cover, often referred to colloquially in the industry as a “party top,” to provide shade and protection from the elements to users. Conventionally, such covers or party tops are provided with supports at multiple positions, such as at the four corners of a square or rectangular cover. To secure the cover in place, for conventionally constructed watercraft the supports are simply attached directly to the material of the upper deck using fasteners such as lag-screws, bolts, etc. Likewise, conventionally the compartment is often simply fastened to a lower deck disposed at a top region of the hull.

Because decks of watercraft are typically constructed of materials such as wood, fiberglass, fiberglass-sheathed wood and the like, fastening, e.g., the supports for a cover to an upper deck or portions of a passenger compartment to a lower deck using conventional fasteners such as screws and bolts, while initially effective, creates a variety of problems. Over time, the screws or bolts may loosen and cause damage to the upper deck material, lessening the secure fastening of the cover. Further, the damage caused to the upper and/or lower deck material may eventually cause leaks, in turn setting the stage for further water damage to the upper deck and potentially to an interior of the compartment. There accordingly remains a need in the art for means for securing such covers to watercraft such as houseboats, without the disadvantages attendant to conventional construction methods. In turn, improvements can be made in the hull structure of such craft.

### SUMMARY OF THE INVENTION

The aforementioned and other problems become solved by the present disclosure providing an integrated hull and support structure for a watercraft, which avoids the disadvantages discussed above. Still further, the present disclosure sets forth also a drainage system for a watercraft, integrated with particular elements of that support structure. In combination, the support structure and integral drainage system provide an effective means for supporting a cover and for removing water from surfaces of the watercraft, without detracting from the aesthetic appearance of the watercraft exterior. As yet another benefit, the described support structure provides structural support for the hull and at least the exterior sidewalls of the compartment wherein are located the living quarters and other amenities as described above.

The present disclosure provides also a watercraft hull composite construction including multiple materials. In an embodiment, the hull includes an exterior skin, a plurality of frame members, and an inner hull wall, with the plurality of frame members disposed in the gap or void between the exterior skin and the inner hull wall. An intervening filler material is used to filling a gap or void between the exterior skin and the inner hull wall.

In turn, a decking construction is provided including a top and bottom layer defining a space therebetween, with an intervening filler material substantially filling the space between the deck top and bottom layer. In combination with the aforementioned hull construction, a hull structure is provided having superior buoyancy, rigidity, and insulative properties compared to conventional hulls.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings, incorporated in and forming a part of the present disclosure, illustrate various aspects of the invention and, together with the description, serve to explain the principles of the invention. In the drawings:

FIG. 1 shows a side view of a watercraft including the support structure of the present invention;

FIG. 2 shows the support structure of FIG. 1 in end cross-sectional view;

FIG. 3 shows a detail of a connection between a vertical post of the support structure and a cover frame post;

FIG. 4 shows fastening of the support structure to a portion of the watercraft hull sidewall;

FIG. 5 shows a top view of a watercraft including the support structure;

FIG. 6 shows a drain according to the present disclosure;

FIG. 7 shows in cross-section a connection between a drain and a horizontal drain pipe according to the present disclosure;

FIG. 8 shows in cross-section a hull and deck design according to the present disclosure; and

FIG. 9 shows a detail of a hull design according to the present disclosure.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, and/or other changes may be made without departing from the scope of the present invention.

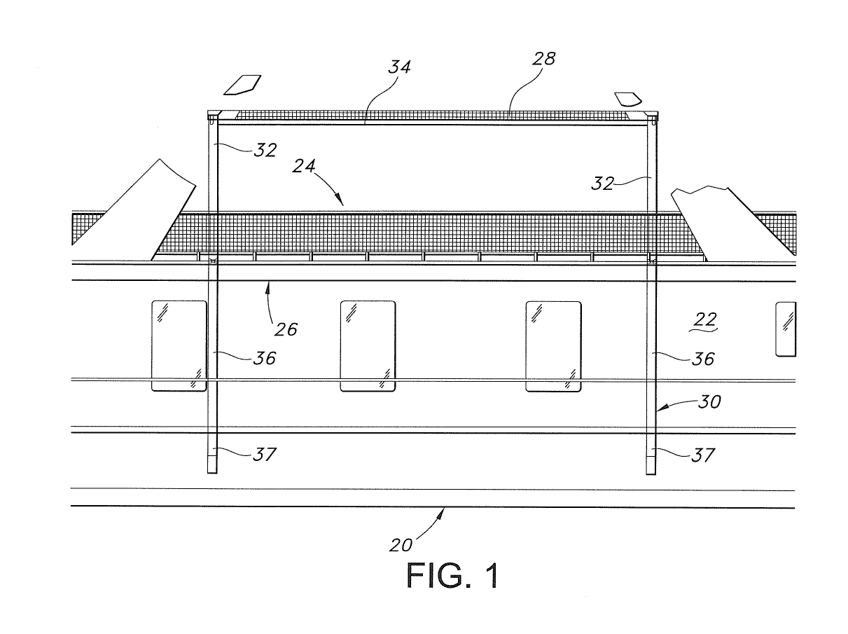

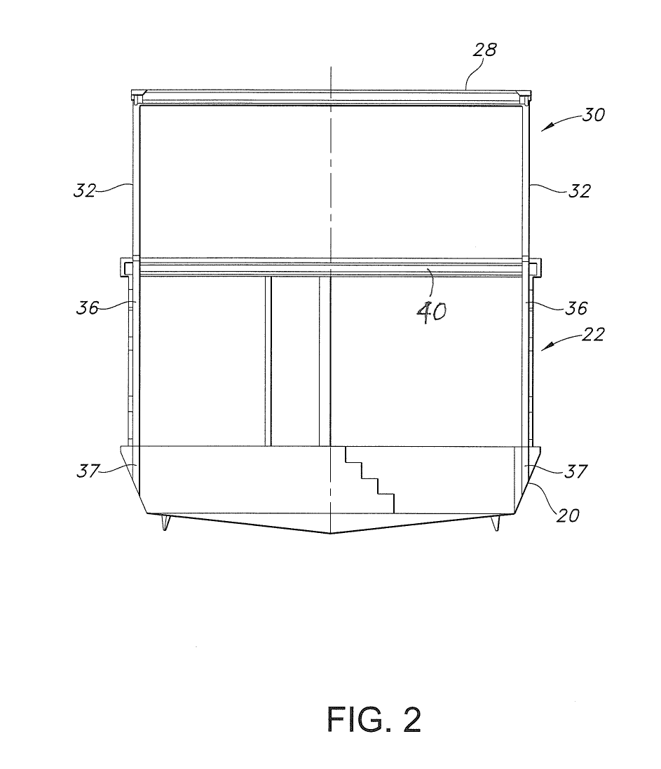

In more detail, as shown in FIGS. 1 and 2 there is provided a support frame 30, including a watercraft party top or cover 28. As shown, the cover 28 is supported by four cover beams or posts 32, one for each corner of the cover 28. However, the skilled artisan will readily appreciate that more or fewer cover posts 32 could be provided if desired or required, in accordance with the size and weight of the cover 28 to be supported. Horizontal braces 34 connect an upper end of each cover post 32 one with the other, defining a substantially geometric frame for supporting the cover 28. The braces 34 are attached to an upper end of the cover posts 32 by any suitable method, such as by welding or by other fastening means.

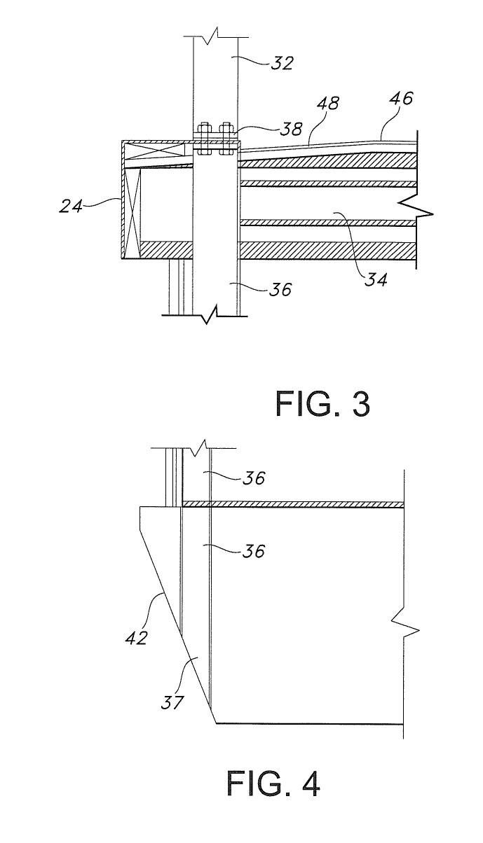

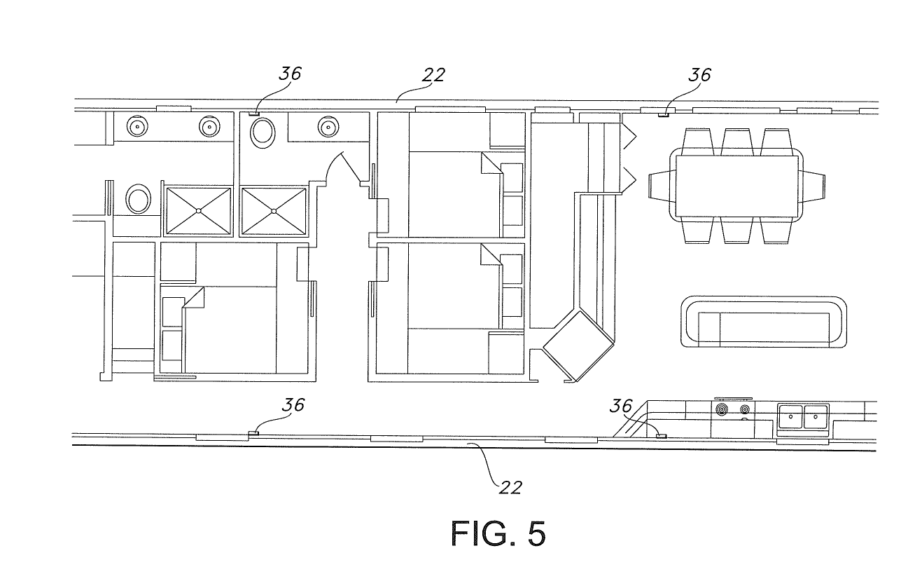

One or more frame members defining the hull 20 (see discussion below) extend vertically to define vertical posts 36, which are positioned at least partially interior to the exterior sidewalls 22 of the watercraft compartment 22. Alternatively, vertical posts 36 may be fastened at an end 37 to hull 20 frame members, such as by suitable fasteners, by welding, etc. The vertical posts 36 may be positioned in a substantially co-linear arrangement with the cover posts 32. As shown in FIG. 3, a bottom end of the cover posts 32 may be fastened to an upper end of the vertical posts 36, such as by bolting or welding one to the other. A suitable gasket 38 and potentially additional sealants may be included therebetween to reduce water entry at the juncture of the cover posts 32 and the vertical posts 36. In addition (see FIG. 2), a plurality of upper deck horizontal braces 40 are provided to fasten an upper end of the vertical posts 36 one to the other. The upper deck horizontal braces 40 may be disposed in an interior or underside of the upper deck 24/compartment 22 roof. Thus, the upper deck horizontal braces 40 provide structural integrity to the support frame 30 (see also FIG. 5) and also serve as support or structural members for the upper deck 24/compartment 22 roof.

Of course, it will be appreciated that rather than the arrangement of cover posts 32 abutting vertical posts 36, it is possible to simply provide vertical posts 36 having sufficient length to allow attaching directly to cover 28, such as at the corners thereof, while still providing sufficient vertical clearance between upper deck 24 and cover 28.

With reference to FIG. 4, the vertical posts 36 are fastened at a bottom end 37 to a sidewall 42 of hull 20. In the depicted embodiment the vertical posts 36 are fastened to the hull 20 sidewall 42 by welding, although any suitable fastening means are contemplated which provide the desired secure fastening without compromising integrity or water-tightness of the hull 20.

The advantages of the described support frame 30 will be readily apparent. The frame allows providing a cover 28 for an upper deck 24 of a watercraft, without the disadvantages of conventional securing methods such as lag screws or bolts inserted into a material of that upper deck 24. That is, as set forth above, the present support frame 30 allows secure fastening of a cover 28 without risk of future loosening of conventional fasteners and attendant damage to the upper deck 24 material.

Likewise, the present support frame 30, via vertical posts 36 and upper deck horizontal braces 40, provide structural support for the watercraft hull 20 and for the compartment 22 sidewalls. As shown in FIGS. 1 and 2, an end 37 of sidewall posts 36 extends into and is secured to a frame member (see discussion below) of the hull 20, providing additional structural support to the hull 20. Even more, this portion of the support frame 30 provides a structural support for the upper deck 24/compartment 22 roof. All this is accomplished with a single, mostly concealed support frame 30, as opposed to multiple exposed supports/load-bearing elements.

In another aspect of the invention, a drainage system 44 is provided that is integral to a portion of the above-described support frame 30. As will be appreciated and as shown in the appended drawing figures (see especially FIG. 3), the upper deck 24 includes a substantially horizontal floor surface 46. Such horizontal floor surfaces collect water such as from rainfall, particularly when upper deck 24 is provided with sidewalls or the like. To prevent such water collection, it is known to provide floor surfaces 46 with at least a portion defining an incline 48 (best seen in FIG. 3). While it is possible to simply discharge water randomly from a side of floor surface 46, more commonly at least one drain is provided which typically discharges water directly overboard or through downspout elements to control the point at which draining water is discharged. Such drainage systems, while for the most part effective, are often highly visible, detracting from the appearance of the vessel. Further, such drain systems, by providing only one or two drainage points, are susceptible to blocking or clogging.

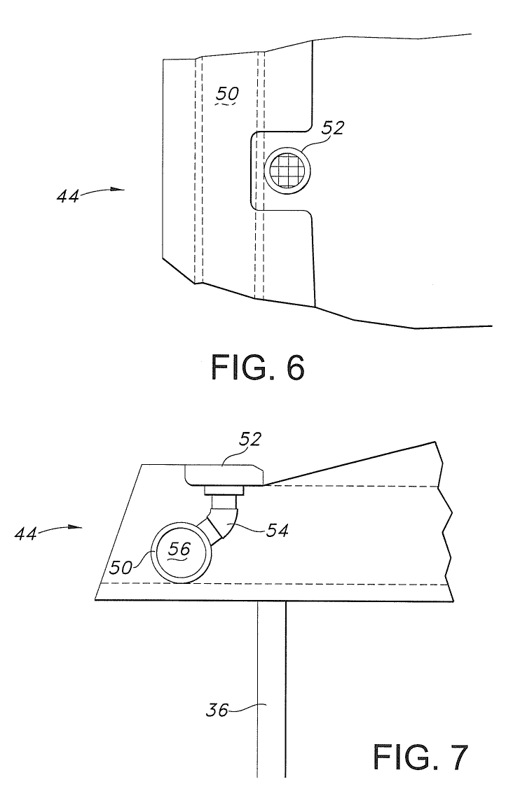

To address this problem, the present invention provides also an improved drainage system 44, comprising at least two horizontal drain pipes 50 positioned at least on opposed longitudinal sides of upper deck 24, typically disposed at a lowest point of incline 48 to maximize water collection. The horizontal drain pipes 50 are typically hidden under soffits defined by an underside of upper deck 24. A plurality of drains 52 (see FIG. 6) are provided at spaced intervals along a length of the horizontal drain pipes 50. Those drains 52 are each fluidly connected to horizontal drain pipes 50, such as by suitable configurations of pipes/elbows 54 as shown in FIG. 7.

The horizontal drain pipes 50 end in at least one discharge 56 for removal of water, but may discharge at both ends, fore and aft of a centerpoint of the watercraft. As shown in FIG. 7, each end of the horizontal drain pipes 50 exits at or near a sidewall post 36 and uses that sidewall post 36 substantially as a downspout to direct discharged water draining from the upper deck 24.

The hull 20 of the present disclosure provides another advantageous feature. With reference to FIG. 8, the hull 20 may be provided as a composite structure. Any suitable exterior hull 20 cross-sectional configuration in accordance with the use intended for the vessel is contemplated. As is known, the hull 20 shape is defined by a plurality of spaced-apart frame members 58. Lateral, longitudinal, diagonal, etc. frame members 58 are disposed to define the hull 20 shape. Of course, additional support/structural elements may be included, such as support beams 60, frame braces 62, and the like, in accordance with the size of the hull 20, the weight/displacement of the watercraft, and other engineering considerations. As set forth above, an end 37 of vertical posts 36 of frame 30 provides a support element for hull 20 (see FIG. 1). The frame members and additional support/structural elements as described may be secured one to the other by any suitable means, although it is typical in the industry to provide welded frame members.

The hull 20 is provided also with an exterior, watertight skin 64 manufactured of at least one panel of material. In an embodiment, exterior skin 64 is manufactured of one or more aluminum panels, although other materials are known for manufacturing vessel hulls and are contemplated for use herein. Exterior skin 64 is secured to frame members 58 by any conventional means, such as welding, riveting, adhesives, and combinations thereof.

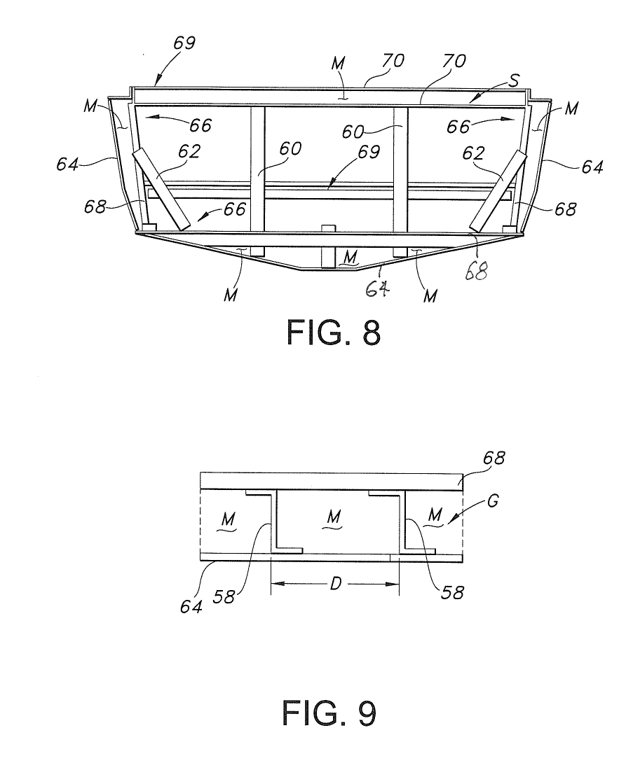

Interior to and in a spaced-apart relationship from the exterior skin 64 is an inner hull wall 66 defined by one or more panels 68. The panels may be manufactured of any suitable material, including metal, wood, fiberglass or other composites, and the like. In an embodiment, panels 68 are of plywood for economy and ease of use. Panels 68 are secured, e.g., to frame members 58 (see FIG. 9) such that a gap G is defined between panels 68 and exterior skin 64.

Gap G is substantially filled with a suitable filler material M, defining a “sandwich” construct which provides insulative properties and imparts additional rigidity to the hull 20. Any suitable filler material M is contemplated, including a variety of natural and synthetic materials. A number of suitable filler materials are known and contemplated for use herein, including without limitation polyethylene, polystyrene, urethane, and others. Filler material M may be provided as one or more sheets or layers of material prior to securing panels 68 to frame members 58. Alternatively, material M may be provided in liquid or foam form, and injected, sprayed, or poured into gap G after panels 68 are secured to frame members 58. In the latter embodiment, a drying and curing step is contemplated as is known in the art. Advantageously, providing filler material M in liquid/spray form reduces airspace in gap G, and by substantially filling gap G whereby open airspace is at least minimized, further provides additional protection against leaks in the hull 20, such as at welded areas. In an embodiment, a closed-cell foam is used such as polyurethane foam is sprayed into gap G.

A like composite construction may be provided for flooring and side wall elements of the vessel. As shown representatively in FIG. 8, one or more flooring/ceiling/sidewall elements 69 may be defined by upper and lower panels 70, with upper and lower panels 70 defining a space S therebetween and a layer of filler material M as discussed above disposed in space S. The same or a different material M may be used as described above in the construction of hull 20. Typically, a suitably insulative material M will be selected, such as closed-cell foams and the like. Again, material M may be provided as one or more panels of material, or may be injected, poured, or sprayed into space C. Additional insulative properties and rigidity are imparted to flooring/ceiling elements 69 incorporating material M.

It will therefore be appreciated that the present invention solves a multitude of problems. A support frame 30 is provided that concomitantly supports a cover 28 and provides structural support and improves the structural integrity of the watercraft upper deck 24 and compartment sidewalls 22/hull 20. Still further, an integral drainage system 44 is described which is substantially concealed, and which utilizes a portion of the support frame 30 in preventing collection of water on and discharging water from that upper deck 24. Each of the described elements, that is, the support frame 30 and drainage system 44, are for the most part concealed and do not detract from the aesthetic appearance of a watercraft such as a houseboat.

In turn, a hull 20 construction is described which exhibits reduced distortion or flex compared to conventional construction, even in the most extreme running conditions. In turn, additional insulative and leak resistance properties are imparted by the described hull 20 and flooring/ceiling 69 construction. For example, use of material M such as the described polyurethane foam insulates, e.g., passenger cabin and engine compartments against leaks and condensation. Moreover, the use of suitable closed-cell foam imparts additional buoyancy to a vessel incorporating same, compared to conventional vessel hull construction.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures. All such modifications and variations are within the scope of the invention as determined by the present disclosure and claims when interpreted in accordance with the breadth to which they are fairly, legally and equitably entitled.

What is claimed is:

1. A watercraft, comprising:
a hull and at least one compartment disposed at least partially above said hull, said hull including a bow, a stern, a centerline, a starboard side, a port side, and a topline all defined by a plurality of spaced-apart hull frame members;
a plurality of vertical supports extending from at least one said hull frame member and extending vertically above the topline of said hull; and
a plurality of compartment frame members attached to said plurality of vertical supports to define at least a portion of the at least one compartment;
said plurality of vertical supports providing structural support for at least a portion of the hull and the at least one compartment.

2. The watercraft of claim 1, further including at least one exterior hull skin panel attached to a side of said spaced-apart hull frame members, at least one interior hull panel member attached to an opposed side of said spaced-apart hull frame members, and a filler material substantially filling a gap defined between the at least one exterior hull skin panel and the at least one interior hull panel member.

3. The watercraft of claim 2, wherein the filler material is a closed cell foam.

4. The watercraft of claim 3, wherein the filler material is a polyurethane foam.

5. The watercraft of claim 1, wherein a top surface of said at least one compartment defines an upper deck of the watercraft and the plurality of vertical posts further support a cover for the upper deck.

6. The watercraft of claim 5, wherein the cover for the upper deck comprises a plurality of supporting posts and a top surface.

7. The watercraft of claim 1, wherein the upper deck defines an incline for draining water, further wherein at least one drain is provided near a lower portion of said incline, the at least one drain discharging water to at least one of said plurality of vertical posts as a downspout to direct water draining from the upper deck.

8. A method of making a watercraft, comprising:
providing a plurality of spaced-apart hull frame members defining a bow, a stern, a centerline, a starboard side, a port side, and a topline;
providing a plurality of vertical supports each extending from at least one of said hull frame members, said vertical supports extending above the topline of said hull to define a plurality of vertical posts; and
attaching a plurality of compartment frame members to said plurality of vertical posts to define at least a portion of at least one compartment disposed at least partially above the topline of the hull;
said plurality of vertical supports providing structural support for at least a portion of the hull and the at least one compartment.

9. The method of claim 8, including:
attaching at least one exterior skin panel to a side of said spaced-apart hull frame members to define a watertight exterior hull skin;
attaching at least one interior panel member to an opposed side of said spaced-apart hull frame members; and
filling a gap defined between the at least one exterior skin panel and the at least one interior panel member with a filler material.

10. The method of claim 9, wherein the filler material is a closed cell foam.

11. The method of claim 10, wherein the filler material is a polyurethane foam.

12. A support frame for a watercraft, comprising:
a plurality of vertical supports each extending from at least one hull frame member, said vertical supports defining a plurality of support posts for a compartment of said watercraft and providing structural support for at least a portion of a hull of the watercraft and for at least a sidewall of the compartment.

13. The support frame of claim 12, further including a plurality of horizontal frame members connecting said vertical supports one to the other.
